(19) United States
(12) Patent Application Publication
(10) Pub. No.: US 2010/0266130 A1
(43) Pub. Date: Oct. 21, 2010

(54) METHOD FOR DISTRIBUTING KEYS AND APPARATUS FOR USING THE SAME

(75) Inventors: Shen Po LIN, Hsinchu County (TW); Feng Chi Wu, Hsinchu County (TW); Ming Ta Li, Hsinchu County (TW)

Correspondence Address: WPAT, PC;INTELLECTUAL PROPERTY ATTORNEYS, 2030 MAIN STREET, SUITE 1300, IRVINE, CA, 92614, US

(73) Assignee: RALINK TECHNOLOGY CORPORATION, Hsinchu County (TW)

(21) Appl. No.: 12/561,471

(22) Filed: Sep. 17, 2009

(30) Foreign Application Priority Data
Apr. 17, 2009 (TW) 098112742

(51) Int. Cl. H04L 9/08

(52) U.S. Cl. 380/279; 380/270

(57) ABSTRACT

The method and apparatus for distributing keys according to the IEEE 802.11r standard broadcast at least one notify packet from a first access point to other access points within an extended service set when a station has connected to the first access point. If the R0 key holder identifier in a key request packet coming from a second access point matches the R0 key holder identifier held by the first access point, a key response packet is forwarded to the second access point to speed up the handoff procedure between the station and the second access point.

### BACKGROUND OF THE INVENTION

1. Field of the Invention

The present invention relates to a communication system, and more particularly, to a method and apparatus for distributing keys.

2. Description of the Related Art

Wireless local area network (WLAN) technology is now widely used in various applications. Numerous organizations devote extensive resources to research seeking improvements in WLAN data communication quality. In a WLAN, a wireless transmit/receive unit (WTRU) may be located within communication ranges of several access points (APs). However, the AP associated with the WTRU and the channel the WTRU operates on may change due to the WTRU roaming among various APs. Before the WTRU can be associated with another AP for forwarding or receiving packets continuously, a handoff procedure has to be performed.

In order to ensure service qualities for WLAN applications, some requirements for transmission of packets are defined. For example, for voice over IP (VoIP) services, acceptable network transmission environments with good packet data processing performance ensure that the packet delay is less than 150 ms. Users experience echoes and tremolos caused by delays of packets, and thus longer delays will cause poor sound quality for users. According to the IEEE 802.11r standard, the time spent for a WTRU roaming from one AP to another AP is required to be less than 50 ms to maintain the quality of VOIP services in wireless network. Therefore, finding ways to speed up the handoff procedure for a station to associate with an AP is an important issue for the market.

### SUMMARY OF THE INVENTION

The method and apparatus for distributing keys according to the IEEE 802.11r perform the broadcast of at least one notify packet from a first AP to other APs within an extended service set when a station has connected to the first AP. If the R0 key holder identifier in a key request packet coming from a second AP matches the R0 key holder identifier held by the first AP, a key response packet is forwarded to the second AP to speed up the handoff procedure between the station and the second AP.

One embodiment of the present invention discloses a method for distributing keys, comprising the steps of: connecting a station with a first AP; forwarding, by the first AP to other APs, of at least one notify packet; receiving a key request packet coming from a second AP of the other APs; generating a requested key if a first key holder identifier in the key request packet matches a second key holder identifier held by the first AP; generating a key response packet including the requested key; and forwarding the key response packet to the second AP.

Another embodiment of the invention discloses an apparatus for distributing keys, comprising a forwarding unit, a receiving unit, a decrypting unit, a determining unit, a storing unit, an arithmetic unit and an encrypting unit. The forwarding unit is utilized for forwarding a key request packet, a key response packet or a notify packet to other APs. The receiving unit is utilized for receiving key request packets or notify packets forwarded from other APs. The decrypting unit is utilized for decrypting the key request packets or the notify packets received by the receiving unit. The storing unit is utilized for storing R0 key holder identifiers. The determining unit is utilized for determining whether the R0 key holder identifiers in the key request packets received by the receiving unit are the same as the R0 key holder identifier stored in the storing unit. The arithmetic unit 306 is utilized for generating a requested key in accordance with the key request packets received by the receiving unit. The encrypting unit is utilized for encrypting the key request packet, the notify packet or the key response packet including the requested key, all of which are forwarded by the forwarding unit.

### BRIEF DESCRIPTION OF THE DRAWINGS

The invention will be described according to the appended drawings in which:

FIG. 1 is a diagram illustrating a station roaming from the communication range of one AP to the communication range of another AP;

FIG. 2 is a flowchart illustrating the preferred embodiment of the method complied with IEEE 802.11r standard for distributing keys according to the present invention; and

FIG. 3 is a block diagram of the apparatus complied with IEEE 802.11r standard for distributing keys in accordance with another embodiment of the present invention.

### PREFERRED EMBODIMENT OF THE PRESENT INVENTION

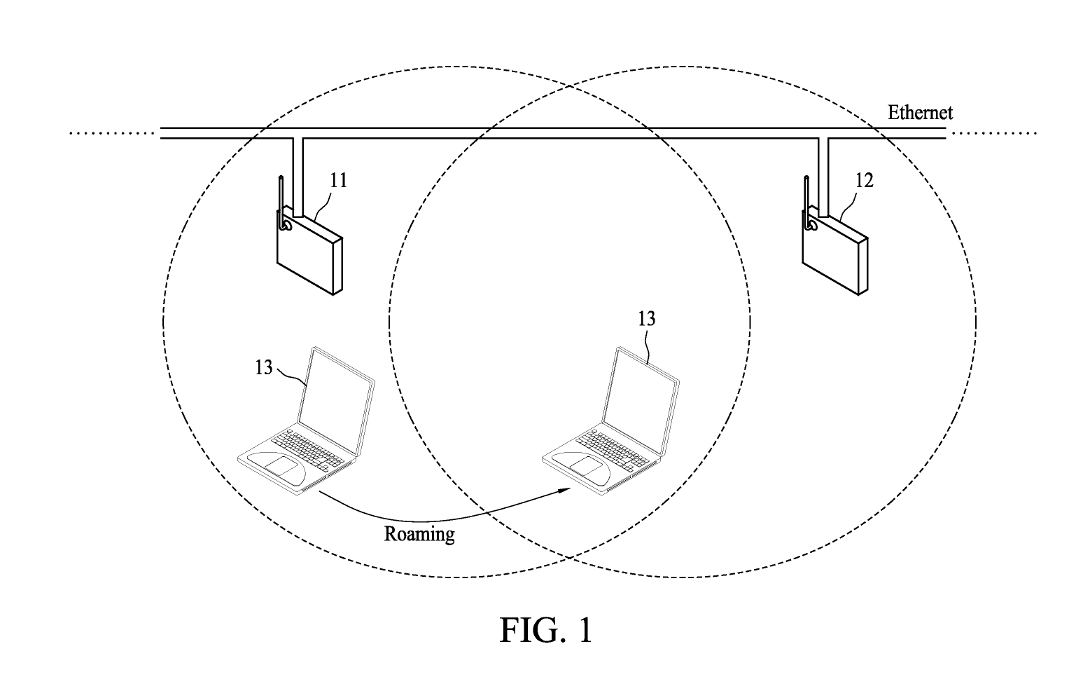

FIG. 1 is a diagram illustrating a station 13 roaming from the communication range of an AP11 to the communication range of an AP12 within an extended service set (ESS). Before the station 13 can be associated with the AP 12 for forwarding or receiving packets continuously, a handoff procedure has to be performed. If the AP 12 has obtained the key needed for connecting with the station 13 before the station 13 roams to the communication range of the AP12, the handoff procedure for connecting the station 13 with the AP 12 can be speeded up. The above-mentioned station 13, AP 12 and AP 11 are compatible with IEEE 802.11r standard.

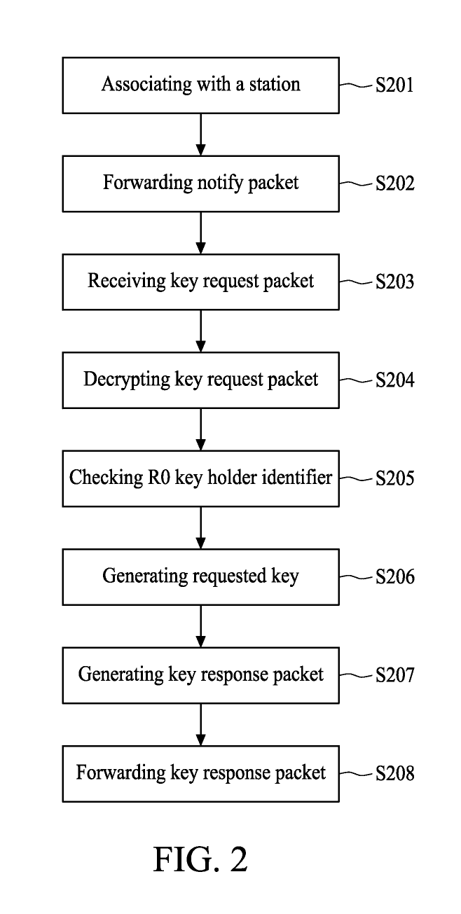

FIG. 2 is a flowchart illustrating the preferred embodiment of the method used for IEEE 802.11r standard for distributing keys of the present invention. The following utilizes FIG. 1 and FIG. 2 together to illustrate the method for distributing keys. In step S201, the AP 11 is associated with the station 13. In step S202, the AP 11 forwards notify packets to other APs which are compatible with IEEE 802.11r standard in the ESS the station 11 belongs to, wherein a broadcast mode is utilized for the AP 11 to forward the notify packets to the other APs. When an AP in the ESS, e.g. the AP 12, receives one of the notify packets, the AP 12 forwards a key request packet to the station 11. If the AP 12 holds the internet protocol (IP) address of the AP 11, a unicast mode is utilized for the AP 12 to forward a transmission control protocol (TCP) key request packet to the AP 11. If the AP 12 does not hold the internet protocol (IP) address of the AP 11, the broadcast mode is utilized for the AP 12 to forward user datagram protocol (UDP) key request packets. In step S203, the TCP key request packet or one of the UDP key request packets forwarded by the AP 12 is received by the AP 11. In step S204, the key request packet is decrypted, wherein an advanced encryption standard (AES) is utilized for decrypting the key request packet. In step S205, the R0 key holder identifier of the key request packet is compared with the R0 key holder identifier held by the AP 11. If these two R0 key holder identifiers are not the same, the key request packet is abandoned. If these two R0 key holder identifiers are the same, a requested key is generated in step S206 for responding to the request of the AP 12. The requested key is the key needed for the handoff procedure performed by the AP 12 and the station 13. In step S207, a key response packet including the requested key is generated. The key response packet is encrypted with the AES. In step S208, the key response packet is forwarded to the AP 12 with the unicast mode, wherein the key response packet is also a TCP packet. The above-mentioned APs forward the notify packet, the key request packet and the key response packet via Ethernet. Persons skilled in the art understand that the first AP associated with the station 13 may be the AP 12 or another AP. The AP 12 and the other AP can also utilize steps S201-S208 to forward keys.

In addition to the above-mentioned method used for IEEE 802.11r standard for distributing keys, an apparatus complied with IEEE 802.11r standard for distributing keys in accordance with another embodiment is described as follows to enable those skilled in the art to practice the present invention.

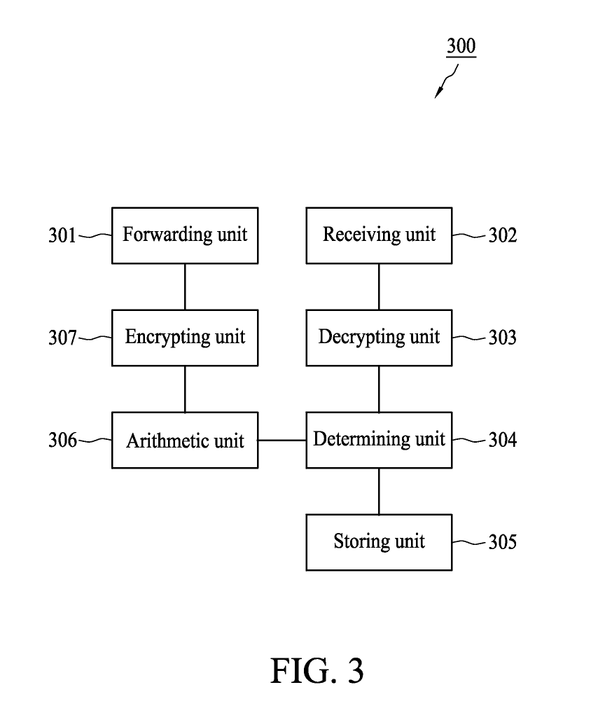

FIG. 3 is a block diagram of the apparatus complied with IEEE 802.11r standard for distributing keys in accordance with another embodiment of the present invention. The apparatus 300 for distributing keys comprises a forwarding unit 301, a receiving unit 302, a decrypting unit 303, a determining unit 304, a storing unit 305, an arithmetic unit 306 and an encrypting unit 307. The apparatus 300 for distributing keys in accordance with another embodiment of the present invention can be utilized for the above-mentioned APs. The forwarding unit 301 is utilized for forwarding a key request packet, a key response packet or a notify packet to an AP or a plurality of APs, wherein the broadcast mode or the unicast mode is set for the forwarding unit 301. The receiving unit 302 is utilized for receiving key request packets or notify packets forwarded from an AP or a plurality of APs. The decrypting unit 303 is utilized for decrypting the key request packets or the notify packets received by the receiving unit 302. The storing unit 305 is utilized for storing an R0 key holder identifier. The determining unit 304 is utilized for determining whether R0 key holder identifiers in the key request packets received by the receiving unit 302 are the same as the R0 key holder identifier stored in the storing unit 305. The arithmetic unit 306 is utilized for generating a requested key in accordance with the key request packets received by the receiving unit 302. The encrypting unit 307 is utilized for encrypting the key request packet, the notify packet or the key response packet including the requested key which are forwarded by the forwarding unit 301. Encryption and decryption procedures with AES are utilized for the decrypting unit 303 and the encrypting unit 307. The above-mentioned key request packets and key response packets are TCP packets. In addition, the key request packets can also be UDP packets. The apparatus 300 for distributing keys in accordance with another embodiment of the present invention can be implemented with software or hardware and any of a platform with single processor and a platform with multiple processors.

In summary, the method and apparatus for distributing keys in accordance with the present invention broadcast at least one notify packet from a first AP to other APs within an extended service set when a station has connected to the first AP. If the R0 key holder identifier in a key request packet coming from a second AP matches the R0 key holder identifier held by the first AP, a key response packet is forwarded to the second AP to speed up the handoff procedure between the station and the second AP.

The above-described embodiments of the present invention are intended to be illustrative only. Numerous alternative embodiments may be devised by persons skilled in the art without departing from the scope of the following claims.

What is claimed is:

1. A method for distributing keys, comprising the steps of:
connecting a station with a first access point (AP);
forwarding at least one notify packet from the first AP to other APs;
receiving a key request packet from a second AP of the other APs;
generating a requested key if a first key holder identifier in the key request packet matches a second key holder identifier held by the first AP;
generating a key response packet including the requested key; and
forwarding the key response packet to the second AP.

2. The method of claim 1, wherein the notify packet, the key request packet and the key response packet are encrypted and decrypted according to advanced encryption standard (AES).

3. The method of claim 1, wherein the first AP forwards the at least one notify packet to the other APs within an extended service set (ESS).

4. The method of claim 3, wherein a broadcast mode is utilized for the first AP to forward the at least one notify packet to the other APs within an extended service set (ESS).

5. The method of claim 1, wherein the key request packet and the key response packet are transmission control protocol (TCP) packets forwarded with a unicast mode.

6. The method of claim 1, wherein the key request packet is a user datagram protocol (UDP) packet.

7. The method of claim 1, wherein the requested key is a key needed for transmissions between the second AP and the station.

8. The method of claim 1, wherein the key response packet is forwarded to the second AP with a unicast mode.

9. The method of claim 1, wherein the notify packet, the key request packet and the key response packet are forwarded by the first AP, the second AP and the other APs via Ethernet.

10. The method of claim 1, wherein the station, the first AP, the second AP and the other APs are compatible with IEEE 802.11r standard.

11. An apparatus for distributing keys, comprising:
a decrypting unit configured to decrypt a first key request packet or a first notify packet;
a storing unit configured to store a first key holder identifier;
a determining unit configured to determine whether a second key holder identifier in the key request packet is the same as the first key holder identifier;
an arithmetic unit configured to generate a requested key in accordance with the first key request packet;
an encrypting unit configured to encrypt a second key request packet, a second notify packet or a key response packet including the requested key; and
a forwarding unit configured to forward the second key request packet, the key response packet or the second notify packet.

12. The apparatus of claim 11, further comprising a receiving unit configured to receive the first key request packet or the first notify packet.

13. The apparatus of claim 11, wherein a broadcast mode is set for the forwarding unit.

14. The apparatus of claim 11, wherein a unicast mode is set for the forwarding unit.

15. The apparatus of claim 11, wherein the decrypting unit and the encrypting unit execute encryption and decryption procedures, respectively, according to advanced encryption standard (AES).

16. The apparatus of claim 11, wherein the first key request packet, the second key request packet and the key response packet are transmission control protocol (TCP) packets.

17. The apparatus of claim 11, wherein the first key request packet and the second key request packet are user datagram protocol (UDP) packets.

18. The apparatus of claim 11, which is implemented with software, hardware, or a platform with single processor or with multiple processors.

19. The apparatus of claim 11, which is utilized for devices compatible with IEEE 802.11r standard.
